(19) United States
(12) Patent Application Publication
(10) Pub. No.: US 2008/0026699 A1
(43) Pub. Date: Jan. 31, 2008

(54) Push-to-talk switch

(76) Inventor: Richard C. Smith, Costa Mesa, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/493,242

(22) Filed: Jul. 26, 2006

(51) Int. Cl. H04B 1/38; H04M 1/00

(52) U.S. Cl. 455/90.2; 455/575.1

(57) ABSTRACT

A push-to-talk switch can have a diaphragm that is supported about a periphery thereof and can have a thicker portion which defines a button. A bezel can be configured so as to guide a user's finger to the button. A magnetic switch can be used to provide the momentary contact required for radio transmissions. Thus, a push-to-talk switch that has enhanced reliability is provided. More particularly, the push-to-talk switch of the present invention is more likely to operate properly regardless of how the button thereof is pushed and is less likely to fail during operation.

### TECHNICAL FIELD

The present invention relates generally to electronics. The present invention relates more particularly to a push-to-talk switch for use with a portable two-way radio, such as one of the portable two-way radios commonly used by police officers, fireman, and soldiers.

### BACKGROUND

Portable two-way radios are well known. Police officers, fireman and soldiers commonly use portable two-way radios to communicate when performing their duties. Such radios generally require that a switch be actuated for the user to transmit a radio message. Such switches are known as push-to-talk switches

For example, police officers are often seen using the push-to-talk button on the microphone of their two-way radio so that they can speak over the radio. Other push-to-talk switches are not built into the microphone, but rather are standalone switches that can be attached to a radio cable, such as between an earpiece and/or microphone and the two-way radio.

The cable is configured to facilitate control of the radio via the standalone push-to-talk switch. That is, pushing the button of the standalone push-to-talk switch completes a circuit though the cable so as to cause the radio to transmit in the same manner that pushing the button of the microphone does.

Standalone push-to-talk switches are generally used in critical situations, such as in covert police operations and in firefighting. In covert police operations, the push-to-talk switch can be worn beneath the clothes, e.g., under a shirt. An earpiece can be used to enhance the ability of a user to hear received radio messages and to inhibit the ability of others to hear these messages (which can be particularly important in covert police operations).

Although contemporary standalone push-to-talk switches have proven to be generally satisfactory for their intended uses, they do suffer from inherent deficiencies that detract from their overall utility. For example, when an attempt is made to push the button of a contemporary standalone push-to-talk switch, the user must be careful to push the button directly downwardly (normal to the surface of the button) and to push at the center of the button. This careful procedure must be followed in order to obtain reliable operation of the switch. Otherwise, the radio may not transmit. The failure to transmit can, in some instances, be life threatening.

Proper use of a contemporary push-to-talk switch may be difficult, particularly in stressful situations (such as when a police officer is under fire). In such instances, the user may have a tendency to stab at the button with much less care, because the user is distracted by more important matters. Yet, it is precisely in such instances that reliable operation of the switch is most needed.

Further, contemporary push-to-talk switches use spring switches. As those skilled in the art will appreciate, spring switches commonly have a life of a few hundred thousand cycles. Such short lives undesirably increase the likelihood of failure during use. Such failure can have catastrophic consequences.

In view of the foregoing, it is desirable to provide a standalone push-to-talk switch that has enhanced reliability. More particularly, it is desirable to provide a standalone push-to-talk switch that is more likely to operate properly regardless of how the button thereof is pushed and which is less likely to fail during operation.

### BRIEF SUMMARY

Systems and methods are disclosed herein to provide enhanced operation of a portable two-way radio system having a push-to-talk switch. More specifically, in accordance with one embodiment of the present invention a push-to-talk switch comprises a diaphragm that has a peripheral portion and a thicker portion. The diaphragm is supported about the peripheral portion thereof. The thicker portion of the diaphragm defines a button that can be pressed to actuate the push-to-talk switch. The button is configured so as to make operation of the switch easier and more reliable. The diaphragm both defines the button and seals the push-to-talk switch to prevent moisture, particulates, and atmospheric contamination from adversely affecting operation of the thereof. The diaphragm also provides a spring force that returns the button to its unactuated position after use.

The peripheral portion and the thicker portion of the diaphragm can be integrally formed. The peripheral portion and the thicker portion can be formed of a resilient polymer material, such as rubber. The thicker portion can be formed centrally with respect to the peripheral portion. The diaphragm and/or the button can be generally round. The diaphragm and the button do not have to have the same shape.

The peripheral portion can be between approximately 0.010 inch and approximately 0.100 inch thick. The peripheral portion can be approximately 0.040 inch thick. The thicker portion can be between approximately 0.10 inch and approximately 0.35 inch thick. For example, the thicker portion can be approximately 0.25 inch thick.

A bezel can be configured so as to guide a user's finger to the button. More particularly, the bezel can have a sloped portion that has a width of between approximately 0.25 inch and approximately 1.5 inch. For example, the bezel can have a sloped portion that has a width of approximately 0.75 inch. The sloped portion can have an angle of between approximately 35° and approximately 55°. For example, the sloped portion can have an angle of approximately 45°. The sloped portion guides a finger than misses the button toward the button so as to enhance the likelihood of actuating the switch.

The push-to-talk switch can comprise a magnetic switch that is configured such that pushing the button actuates the magnetic switch. For example, pushing the button can move a switch contact against magnetic force so as to close contacts and thereby make a circuit. However, other switch configurations are also suitable.

The magnetic switch can be mounted upon a printed circuit board such that pushing the button actuates the switch. More particularly, pushing the button can cause the thicker portion of the diaphragm to move downwardly so as to depress a post of the magnetic switch in a manner that effects actuation thereof. The printed circuit board can be fabricated without the use of lead, e.g., by using silver traces and silver solder instead.

The printed circuit board and the magnetic switch can be disposed within a housing. Sufficient room can be provided within the housing for an electrical cable to pass through the housing between the circuit board and the housing. One or more wires from the cable can be used to provide electrical communication between the switch and a portable two-way radio so as to facilitate push-to-talk functionality. Other cables and/or wires can pass through the housing and can facilitate communication between the radio and an earpiece and/or a microphone.

The housing can be formed of aluminum (such as anodized aluminum) or any other substantially rigid, durable material such as another metal or a polymer. The housing can be machined, molded, or formed by any other desired method.

A push-to-talk switch can be used to make an inline cable assembly for a portable two-way radio, according to an exemplary embodiment of the present invention. A push-to-talk switch can be used to make a portable two-way radio system, according to an exemplary embodiment of the present invention.

Benefits of the push-to-talk switch of the present invention include enhanced ease of use and enhanced reliability. This invention will be more fully understood in conjunction with the following detailed description taken together with the following drawings.

### BRIEF DESCRIPTION OF THE DRAWINGS

FIG. 1 is a semi-schematic perspective view of a push-to-talk switch according to an exemplary embodiment of the present invention;

FIG. 2 is a semi-schematic exploded view of the push-to-talk switch of FIG. 1, showing the bezel assembly and o-ring removed from the housing thereof;

FIG. 3 is a semi-schematic top view of the bezel assembly of FIG. 2;

FIG. 4 is a semi-schematic bottom view of the bezel assembly of FIG. 2;

FIG. 5 is a semi-schematic exploded perspective view of the bezel assembly of FIG. 2, showing a top view of the diaphragm (including the button) and showing the retainer removed from the bezel;

FIG. 6 is a semi-schematic perspective view showing the bottom of the diaphragm of FIG. 5;

FIG. 7 is a semi-schematic side view of the diaphragm of FIG. 5;

FIG. 8 is a semi-schematic cross-sectional view taken along line 8 of FIG. 1;

FIG. 9 is a semi-schematic view of an inline cable assembly using a push-to-talk switch according to an exemplary embodiment of the present invention;

FIG. 10 is a semi-schematic view of an earpiece assembly, comprising a cable, a speaker, acoustic tubing, and an earpiece, that is suitable for use with the inline cable assembly of FIG. 9 so as to partially define a portable two-way radio system according to an exemplary embodiment of the present invention; and

FIG. 11 is a semi-schematic view of a portable two-way radio system as worn by a user, according to an exemplary embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

A standalone push-to-talk switch for use with portable two-way radios and the like is disclosed. The push-to-talk switch is configured such that it tends to operate properly regardless of how the button thereof is pushed. It is also substantially more reliable than contemporary push-to-talk switches.

According to one aspect of the present invention, the push-to-talk switch is configured such that the switch is more likely to actuate when pushed near the edge of the button (the top of the button proximate its perimeter, rather than at the center thereof) or at an angle (rather than perpendicularly), as compared to contemporary push-to-talk switches. According to one aspect of the present invention, the push-to-talk switch has an enhanced bevel that tends to ensure that the switch is actuated when an attempt to depress the button thereof is made. According to one aspect of the present invention, reliability of the push-to-talk switch is enhanced by using a magnetic switch rather than a spring switch.

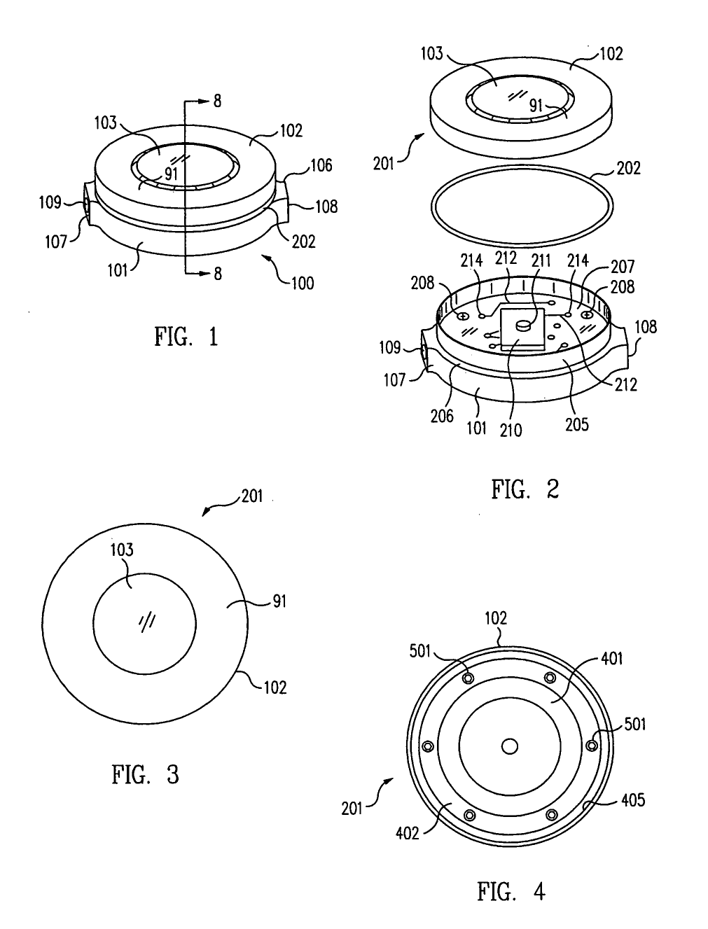

Referring now to FIG. 1, according to one aspect of the present invention a push-to-talk switch 100 comprises a housing 101, a bezel 102 attached to housing 101, and a button 103 disposed within bezel 102. Push-to-talk switch 100 can be used by police officers (particularly when involved in covert operations) and firemen to facilitate use of a portable two-way radio.

For example, a covert police officer can wear push-to-talk switch 100 underneath a shirt so that it is hidden from view. A small, unobtrusive microphone can be hidden, such as beneath the collar. An unobtrusive earpiece can be worn to facilitate listening to received radio communications. The portable two-way radio can be worn on the belt and hidden beneath a jacket. In this manner, the officer's ability to communicate by radio is not apparent to casual observers.

When an officer wants to transmit a radio communication, button 103 of the push-to-talk switch 100 can be pushed through the officer's shirt. Wide, sloped bezel 102 guides the user's finger to button 103 so as to assure proper actuation of the switch. As discussed in detail below, the width and slope of bezel 102 are configured so as to enhance the ability thereof in such guiding.

As also discussed in detail below, button 103 is configured so that the switch is more likely to be actuated regardless of the direction or angle with which a finger presses button 103. Contemporary standalone push-to-talk switches should be pressed normally, proximate the center thereof, in order to assure reliable actuation of the switch. Pressing the button of a contemporary push-to-talk switch normally near an edge thereof, or at an angle (particularly near the edge thereof) does not result in reliable operation of the switch. However, pressing button 103 of the present invention normally near the center thereof, normally near an edge thereof, at an angle (either near the center or the edge) is more likely to result in actuation of the switch than is the case with a contemporary push-to-talk switch.

Housing 101 can have bosses 106 and 107 formed thereon. One boss 106 can be longer than the other boss 107. Alternatively, both bosses can be the same size. Bosses 106 and 107 can be diametrically opposed about housing 101. Alternatively, bosses 106 and 107 can have any other desired orientation. For example, bosses 106 and 107 can be perpendicular with respect to one another. Any desired number of bosses can be used. Thus, one, two, three, four, or more bosses can be used.

Openings 108 and 109 can be formed in bosses 106 and 107 to facilitate the passage of one or more cables through housing 101. Such a cable can, for example, provide electrical communication between a switch disposed within housing 101 and a portable two-way radio. The cable can also provide electrical communication between the two-way radio and a microphone and/or earpiece. Thus, the cable can pass through housing 101 and/or can provide electrical connection to circuitry within housing 101. A sealant, such as RTV (room temperature vulcanizing) silicone rubber can be used to provide a water resistant seal between any cable(s) passing through openings 108 or 109 and housing 101.

An o-ring 202 can provide a seal between bezel 102 and housing 101. Alternatively, any other desired means for providing a seal can be used. For example, silicon sealant can be used to provide the seal. Bezel 102 can be removably attached to housing 101, such as via threads. Bezel 102 can be attached to housing 101 by other methods, such as a friction fit. Alternatively, bezel 102 can be permanently attached to housing 101.

Housing 101 and bezel 102 can be formed from aluminum. Housing 101 and bezel 102 can comprise anodized aluminum. Housing 101 and bezel 102 can be formed by machining. Alternatively, housing 101 and bezel 102 can comprise a rigid polymer material or any other desired material. Housing 101 and bezel 102 can be formed by injection molding.

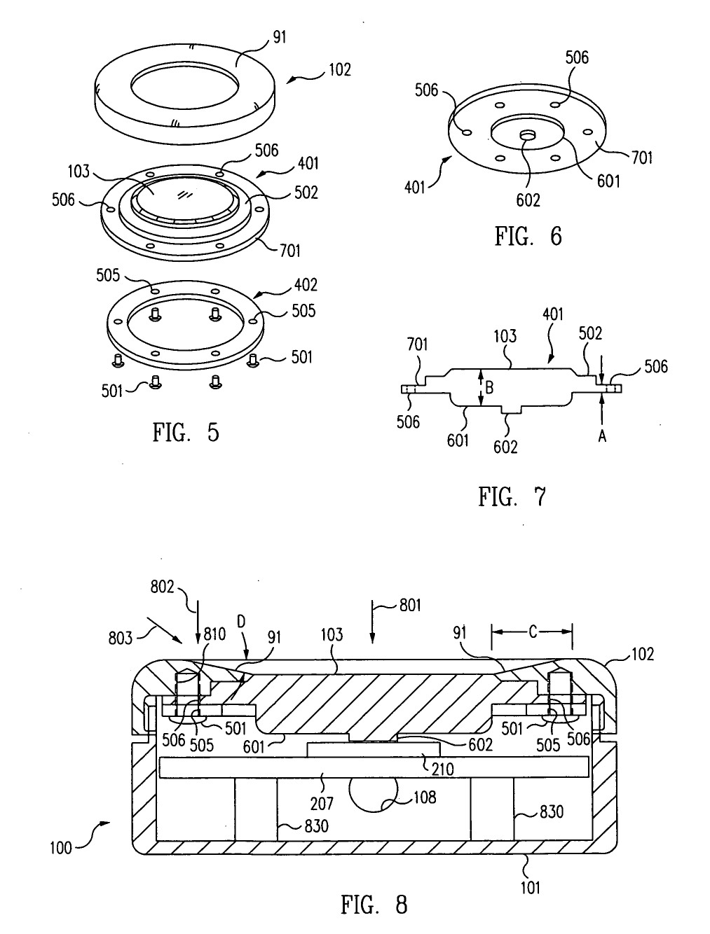

Button 103 can be part of a diaphragm that seals housing 101, as discussed in detail below. Alternatively, the button and the diaphragm can be two separate components of the push-to-talk switch. Button 103 (and diaphragm 401 of FIG. 5) can be formed of a resilient polymer such as rubber.

As mentioned above, bezel 102 can be sloped (as best seen in FIG. 8) such that it tends to guide a finger toward button 103. Thus, bezel 102 makes it easier to push button 103. This can be important when push-to-talk switch 100 is worn beneath the user's clothing. It can also be important is hostile situations, such as when a user is being fired upon and is frantically trying to push the button while defending himself.

Referring now to FIG. 2, a bezel assembly 201 comprises bezel 102, button 103, and other parts as discussed in detail below. Bezel assembly 201 can screw onto housing 101, such as via external threads 205 formed on housing 101 and corresponding internal threads 405 (FIG. 4) formed inside bezel 102. When bezel assembly 201 is screwed onto housing 101, o-ring 202 can be captured therebetween. An o-ring groove 206 formed in housing 101 can receive o-ring 202 and can help to retain o-ring 202 in place when bezel assembly 201 is removed from housing 101.

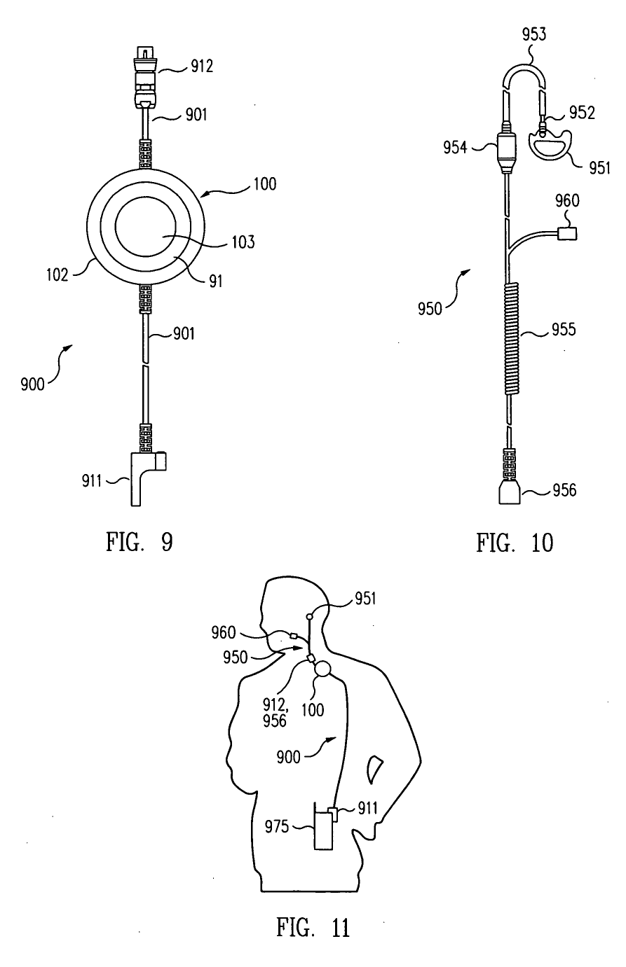

A printed circuit board 207 can be mounted within housing 101, such as via screws 208. A switch, such as magnetic switch 210, can be mounted to printed circuit board 207. Switch 210 can have a post 211 that extends therefrom such that when button 103 is pushed, button 103 depresses post 211 in a manner that actuates switch 210. Traces 212 can be formed on printed circuit board 211 to facilitate electrical interconnection of wires from a cable 901 (FIG. 9) with switch 210. For example, wires from cable 901 can be soldered into through holes 214 to facilitate such electrical connection.

As those skilled in the art will appreciate, the use of a magnetic switch 210, rather than a spring switch (as is used in contemporary push-to-talk switches) provides a substantial advantage with respect to reliability. Spring switches are typically rated for several hundred thousand operations. By way of contrast, magnetic switches can be rated for 500,000,000 operations. Thus, it is clear that the likelihood of failure is substantially less with a magnetic switch than with a spring switch.

As used herein, a spring switch can be defined as a normally open (closed) electrical switch wherein contacts thereof are held apart (together) with a spring. As used herein, a magnetic switch can be defined as a normally open (closed) electrical switch wherein contacts thereof are held apart (together) with one or more magnets. Those skilled in the art will appreciate that other configurations of such switches are possible and that magnetic switches having other configurations can be suitable for use with the present invention.

Referring now to FIG. 3, button 103 can be round and can be centrally located within bezel 102. Alternatively, button 103 and bezel 102 can have any other desired configuration. For example, button 103 and/or bezel 102 can be generally rectangular in shape.

Referring now to FIGS. 4 and 5, bezel assembly 210 comprises a diaphragm 401 that is attached to bezel 102. Diaphragm 401 can be attached to bezel 102 using retainer 402. Retainer 402 can be shaped generally like a washer and can be formed of aluminum. Alternatively, retainer 402 can be formed of a substantially rigid polymer material or any other desired material.

Diaphragm 401 can have button 103 formed integrally therewith. For example, diaphragm 401 and button 103 can be formed of rubber and molded as a single item. Alternatively, diaphragm 402 and button 103 can be formed of a resilient polymer material or any other desired material and can be either integrally or separately formed.

Retainer 402 can be configured as a washer that has a plurality of holes 505 therein such that retainer 402 can capture a peripheral portion of diaphragm 401 between itself and bezel 102 and such that a plurality of screws 501 can be used to attach diaphragm 401 to bezel 102. Screws 501 can pass through unthreaded holes 505 in retainer 402 and through unthreaded holes 506 in diaphragm 401 and then be received into threaded holes 810 (FIG. 8) formed in bezel 102.

Diaphragm 401 can have an intermediate portion 502. The thickness of intermediate portion 502 can be greater than the thickness of peripheral portion 701 and less than the thickness of button 103. Intermediate portion 502 can have a thickness that, at least in part, defines the amount of force required to push button 103 sufficiently so as to actuate switch 210.

Button 103 can comprise a thicker portion of diaphragm 401. The thicker portion of diaphragm 401 that defines button 103 can be thicker than intermediate portion 502. Button 103 can be the thickest portion of diaphragm 401.

Referring now to FIGS. 6 and 7, the bottom of diaphragm 401 can comprise a thicker portion 601 that corresponds generally in position to the thicker portion of diaphragm 401 that defines button 103. That is, button 103 can be defined by an increase in the thickness of diaphragm 401 that extends both upwardly (above peripheral portion 701) and downwardly (below peripheral portion 701). Alternatively, button 103 can be defined by an increase in the thickness of diaphragm 401 that extends either upwardly (above peripheral portion 701) or downwardly (below peripheral portion 701), but not both.

The rigidity of button 103 and the resilience of peripheral portion 701 depend upon the material selected and the thickness thereof. Thus, increasing the thickness of peripheral portion 701 and/or button 103 can increase the rigidity thereof. Button 103 can have sufficient rigidity (such as by having sufficient thickness) so as to effect actuation of switch 210 regardless of where on button 103 it is pushed and with less regard as to the angle at which button 103 is pushed.

A nipple 602 can extend from the lower surface of diaphragm 401 to facilitate contact with post 211 of switch 210. Thus, when button 103 is pushed, then nipple 602 presses downwardly against post 211, so as to effect actuation of switch 210. The length of nipple 602 can be adjusted, either in manufacture of diaphragm 401 or in assembly of push-to-talk switch 100, so as to properly effect actuation of switch 210. For example, nipple 602 can be formed during manufacture to have excessive length and can be trimmed during assembly to have the desired length, thereby compensating for variations in the construction and mounting of switch 210.

A peripheral portion 701 of diaphragm 401 can have a thickness, Dimension A, that is between approximately 0.010 inch and 0.100 inch thick. The peripheral portion 701 can have a thickness, Dimension A, that is approximately 0.040 inch thick. The peripheral portion 701 can be captured intermediate retainer 402 and bezel 102. Peripheral portion 701 provides at least some of the flexibility and resilience that facilitates movement of button 103.

The thicker portion defines button 103 and can have a thickness, Dimension B, that is between approximately 0.10 inch and 0.35 inch thick. The thicker portion can have a thickness, Dimension B, that is approximately 0.25 inch thick. Generally, the thicker portion is thick enough to facilitate use thereof as a button. Thus, the thicker portion is thick enough to provide sufficient rigidity to facilitate use thereof as a button.

Referring now to FIG. 8, a cross-sectional view better shows the sloped portion 91 of bezel 102. Sloped portion 91 can have a width, Dimension C, that is between approximately 0.25 inch and approximately 2.0 inch. Sloped portion 91 can have a width, Dimension C, that is approximately 0.75 inch. Sloped portion can have an angle, Angle D, that is between approximately 35° and approximately 55°. Sloped portion 91 can have an angle, Angle D, that is approximately 45°.

The width, Dimension C, and the angle, Angle D, of sloped portion 91 are configured so as to enhance the ability of a user to actuate the push-to-talk switch of the present invention. Thus, it is substantially more likely that an attempt to actuate the switch will actually result in the ability of the user to transmit a radio message. As those skilled in the art will appreciate, such ability can have life and death consequences. There are times when the ability to rapidly and reliably transmit radio messages can have an important impact upon police and firefighter operations.

Printed circuit board 207 can be mounted to housing 101 via standoffs 830. Screws 208 (FIG. 2) can mate with threads formed in standoffs 830. Standoffs 830 can define the distance between housing 101 and printed circuit board 207. The distance between housing 101 and printed circuit board 207 can be sufficient for one or more electrical cables (such as 901 of FIG. 9) to pass therebeneath. This distance can be varied so as to accommodate the desired amount of cabling within housing 101.

Referring now to FIG. 9, an inline cable assembly 900 can comprise a push-to-talk switch 100 such as that of FIGS. 1-8. A side mount 911, for example, can be attached to the lower end of cable 901 to facilitate electrical connection of cable 901 to a portable two-way radio. As those skilled in the art will appreciate, side mounts can contain impedance matching electronics and are commonly used to attach microphones, speakers, and push-to-talk switches to portable two-way radios. A connector 912, for example, can be attached to the upper end of cable 901 to facilitate electrical connection of cable 901 to a speaker. Connector 912 can be a Hirose connector.

Referring now to FIG. 10, an example of an earpiece assembly 950 that is suitable for use with the push-to-talk switch of the present invention is shown. An electrical connector, such as a connector 956 facilitates electrical connection of an electrical cable 955 to a cable, such as cable 901 of inline cable assembly 900 of FIG. 9. Connector 956 can be a Hirose connector. A speaker 954 generates sound in response to received radio messages. Speaker 915 can be a miniature or button speaker similar to those commonly used in hearing aids. The sound is communicated via acoustic tubing 953 to earpiece 951. A barbed fitting 952, such as an elbow fitting, can be used to attach earpiece 951 to acoustic tubing 953. Earpiece 951 can be disposed in the conchae of a user's ear and directs sound from acoustic tubing 953 towards the user's eardrum.

Referring now to FIG. 11, a user can wear a portable two-way radio 975. Inline cable assembly 900 communicates electrical signals representative of received radio messages from portable two-way radio 975 to a speaker, as described above. Inline cable assembly 900 also communicates electrical signals representative of transmitted radio messages from a microphone 960 to portable two-way radio 975. Inline cable 900 also transmits a control signal from push-to-talk switch 100 to portable two-way radio 975 so as to facilitate the transmission of outgoing messages from the user.

In view of the foregoing, a standalone push-to-talk switch that has enhanced reliability is provided. More particularly, the standalone push-to-talk switch of the present invention is more likely to operate properly regardless of how the button thereof is pushed. Further, the standalone push-to-talk switch of the present invention is less likely to fail during operation. The standalone push-to-talk switch of the present invention can be smaller and lighter than contemporary push-to-talk switches.

Embodiments described above illustrate, but do not limit, the invention. It should also be understood that numerous modifications and variations are possible in accordance with the principles of the present invention. Accordingly, the scope of the invention is defined only by the following claims.

1. A push-to-talk switch comprising:
a diaphragm, the diaphragm comprising:
a peripheral portion about which the diaphragm is supported; and
a thicker portion that defines a button.

2. The push-to-talk switch as recited in claim 1, further comprising a bezel that is configured so as to guide a user's finger to the button.

3. The push-to-talk switch as recited in claim 1, further comprising a bezel that is configured so as to guide a user's finger to the button, the bezel having a sloped portion that has a width of between approximately 0.25 inch and approximately 1.5 inch.

4. The push-to-talk switch as recited in claim 1, further comprising a bezel that is configured so as to guide a user's finger to the button, the bezel having a sloped portion that has a width of approximately 0.75 inch.

5. The push-to-talk switch as recited in claim 1, further comprising a bezel that is configured so as to guide a user's finger to the button, the bezel having sloped portion that has an angle of between approximately 35° and approximately 55°.

6. The push-to-talk switch as recited in claim 1, further comprising a bezel that is configured so as to guide a user's finger to the button, the bezel having sloped portion that has an angle of approximately 45°.

7. The push-to-talk switch as recited in claim 1, further comprising:
a switch; and
wherein pushing the button actuates the switch.

8. The push-to-talk switch as recited in claim 1, further comprising:
a magnetic switch; and
wherein pushing the button actuates the magnetic switch.

9. The push-to-talk switch as recited in claim 1, further comprising:
a switch; and
wherein pushing the button causes the thicker portion of the diaphragm to actuate the switch.

10. The push-to-talk switch as recited in claim 1, further comprising:
a printed circuit board; and
a switch mounted to the printed circuit board such that pushing the button actuates the switch.

11. The push-to-talk switch as recited in claim 1, further comprising:
a printed circuit board;
a switch mounted to the printed circuit board such that pushing the button actuates the switch;
a housing within which the printed circuit board is disposed; and
wherein sufficient room is provided within the housing for an electrical cable to pass through the housing between the circuit board and the housing.

12. The push-to-talk switch as recited in claim 1, wherein the peripheral portion and the thicker portion are integrally formed.

13. The push-to-talk switch as recited in claim 1, wherein the peripheral portion and the thicker portion are formed of a resilient polymer material.

14. The push-to-talk switch as recited in claim 1, wherein the peripheral portion and the thicker portion are formed of rubber.

15. The push-to-talk switch as recited in claim 1, wherein the thicker portion is formed centrally with respect to the peripheral portion.

16. The push-to-talk switch as recited in claim 1, wherein the diaphragm is generally round.

17. The push-to-talk switch as recited in claim 1, wherein the peripheral portion is between approximately 0.010 inch and 0.100 inch thick.

18. The push-to-talk switch as recited in claim 1, wherein the peripheral portion is approximately 0.040 inch thick.

19. The push-to-talk switch as recited in claim 1, wherein the thicker portion is between approximately 0.10 inch and 0.35 inch thick.

20. The push-to-talk switch as recited in claim 1, wherein the thicker portion is approximately 0.25 inch thick.

21. The push-to-talk switch as recited in claim 1, further comprising:
a switch; and
an aluminum housing within which the switch is disposed.

22. The push-to-talk switch as recited in claim 1, further comprising:
a switch;
an aluminum housing within which the switch is disposed; and
wherein the diaphragm provides a seal for the housing.

23. A diaphragm for a push-to-talk switch, the diaphragm comprising:
a peripheral portion about which the diaphragm is supported; and
a thicker portion that defines a button.

24. The diaphragm as recited in claim 23, wherein the peripheral portion and the thicker portion are integrally formed.

25. The diaphragm as recited in claim 23, wherein the peripheral portion and the thicker portion are formed by molding.

26. The diaphragm as recited in claim 23, wherein the peripheral portion and the thicker portion are formed of a resilient polymer material.

27. The diaphragm as recited in claim 23, wherein the peripheral portion and the thicker portion are formed of rubber.

28. The diaphragm as recited in claim 23, wherein the thicker portion is formed centrally with respect to the peripheral portion.

29. The diaphragm as recited in claim 23, wherein the diaphragm is generally round.

30. The diaphragm as recited in claim 23, wherein the peripheral portion is between approximately 0.010 inch and 0.100 inch thick.

31. The diaphragm as recited in claim 23, wherein the peripheral portion is approximately 0.040 inch thick.

32. The diaphragm as recited in claim 23, wherein the thicker portion is between approximately 0.10 inch and 0.35 inch thick.

33. The diaphragm as recited in claim 23, wherein the thicker portion is approximately 0.25 inch thick.

34. An inline cable assembly for a portable two-way radio, the inline cable assembly comprising:
an inline cable configured to provide electrical communication between an earpiece, a microphone, and a portable two-way radio;
a push-to-talk switch, the push-to-talk switch comprising:
a diaphragm, the diaphragm comprising:
a peripheral portion about which the diaphragm is supported; and
a thicker portion that defines a button.

35. A portable two-way radio system comprising:
a portable two-way radio;
a microphone;
an earpiece;
an inline cable assembly for facilitating electrical communication between the two-way radio, the microphone, and the earpiece, the inline cable assembly comprising:
a push-to-talk switch, the push-to-talk switch comprising:
a diaphragm, the diaphragm comprising:
a peripheral portion about which the diaphragm is supported; and
a thicker portion that defines a button.

36. A method for making a push-to-talk switch, the method comprising:
providing a diaphragm having a peripheral portion and a thicker portion that defines a button;
attaching the diaphragm to a housing such that the diaphragm is supported about the peripheral portion thereof; and
placing a switch within the housing such that pushing the button actuates the switch.
